(19) United States
(12) Patent Application Publication
(10) Pub. No.: US 2015/0100625 A1
(43) Pub. Date: Apr. 9, 2015

(54) Data Transmission System

(71) Applicant: INTERCLOUD, Levallois Perret (FR)

(72) Inventors: Jerome Dilouya, Neuilly-Sur-Seine (FR); Benjamin Ryzman, Paris (FR); Gregory Teste, Ivry-Sur-Seine (FR)

(21) Appl. No.: 14/400,206

(22) PCT Filed: May 10, 2013
(86) PCT No.: PCT/EP2013/059754

§ 371 Date: Nov. 10, 2014

(30) Foreign Application Priority Data
May 9, 2012 (FR) 1254238

(51) Int. Cl. H04L 12/24; H04L 29/06

(52) U.S. Cl. CPC H04L 41/0668; H04L 67/42
USPC 709/203

(57) ABSTRACT

A gateway for access to an interconnection network (ICB) of a data transmission system. The gateway includes a first local network, termed a client network, a second local network termed a cloud network and an interconnection network connecting the client network and the cloud network. The gateway is configured to identify and route data of the client network destined for the cloud network.

### 1. CROSS-REFERENCE TO RELATED APPLICATIONS

This Application is a Section 371 National Stage Application of International Application No. PCT/EP2013/059754, filed May 10, 2013, the content of which is incorporated herein by reference in its entirety, and published as WO 2013/167745 on Nov. 14, 2013, not in English.

### 2. FIELD OF THE INVENTION

The invention pertains to a technique for managing the transmission of data. More particularly, the invention relates to a multihoming technique for the interconnection of IP (Internet Protocol) services. For a network, multihoming generally consists in being connected to several Internet service providers in order to improve the reliability of the connection to the Internet.

More particularly, in the context of networks interconnected by the IP protocol and, for a considered host network, multihoming implies being capable of reaching other networks in passing through at least two distinct neighboring networks by option. The goal pursued is to improve the quality and/or the resilience of the network interconnection. The basic principle is the elimination, as far as possible, of any single point of failure on the network path considered.

The invention is more particularly part of the context of Cloud Computing services. The Cloud Computing technique, which is now well known, consists firstly in relocating the storage and computation capacities required for users' requirements to host rooms. This is a development in the application of information technology where the responsibility for procuring supplies and for the daily operations is no longer incumbent on the user companies. The commercial distribution of these computer resources is fine-grained in terms of service units and time units. These two resources are retailed to the user firms.

Often, a distinction is made between three embodiments of implementation of Cloud Computing according to the supplier's level of responsibility:
a. the SaaS mode, or “Software as a Service” mode, designates the provision professional or office software tools in the form of subscriber services and through the purchase of units of use (a certain number of users for one year for example), whereas this type of software is traditionally sold in the form of a license of use, valid for one or more client stations;
b. the PaaS mode, or “Platform as a Service” mode, comprises the supply of software components or “bricks” used to develop complex services made to measure for one or more user firms. This mode is tending to replace the implementation of these same services by platforms deployed and managed on the site of the user firms;
c. the IaaS mode, for “Infrastructure as a Service” mode, implies that the supplier provides computation capacity or raw storage capacity in the form of machines and virtual disks hosted on its own infrastructure.

### 3. PRIOR-ART SOLUTIONS

Several issues and problems are being faced by firms that seek to use Cloud Computing techniques and have a virtual interconnection network available between their sites. Indeed, the public infrastructures enable a gain in productivity and a reduction of the investments needed since they serve numerous clients and thus benefit from economies of scale. Now it is not possible to connect up to these structures except through the Internet and therefore through a network structure which by definition is unreliable. The items of data intended for “SaaS” are frequently conveyed by TLS 1.0 which remains vulnerable in practice owing to its intrinsic fragility but also because of external factors such as phishing

Between the different sites of a firm and the public infrastructure that could host its critical services, the data elements are mixed with the ordinary Internet traffic (in which they are hard to identify). They then pass through several networks: the local area network of the site, the wide area network of the firm (through virtual circuits set up by the transport network of the chosen operator), several operator networks following variable engineering rules and contention ratios (depending on the path taken on the Internet), and then the network providing interconnection to the Cloud infrastructure supplier and finally the local area network providing connection to the Cloud servers.

It can be observed that the firm has a contractual relationship with only one of the operators: the one that provides it with its wide area network. Besides, the mixture of critical data in the Internet traffic makes it hard to envisage the implementation of a quality of service policy from end to end and even only on the firm's wide area network since it is impossible to qualify the critical level, and therefore the class of service, of the encrypted data elements without first of all decrypting them.

One solution to this problem could be to implement two parallel Internet accesses, one being used to transport critical data intended for Cloud Computing and the other to transport classic Internet traffic (consulting information, ordering goods and services, exchanging mail, etc). This means that the user firm would have to implement a multihoming mechanism, capable of qualifying the different pieces of data to be transmitted between its wide area network and the different destinations on the Internet. Now, the multihoming mechanism currently used, which is the BGP (Border Gateway

Protocol) is not suited to this type of traffic engineering: it orients the data elements only as a function of their source and destination addresses, but not according to the content of the IP packets. Besides, the Internet access providers are not capable of guaranteeing the path travelled by the data intended for such and such a network since the different possible routes vary over time.

Another solution would consist in setting up WAN optimizing boxes implementing a certain number of techniques improving the performance metrics of the professional applications relative to other data transported through the wide area network: deduplication, compression, optimizing of TCP latency, proxy/cache, preventive correction of errors, exchange of protocols, traffic adjustment, equalization, limiting of connections or of bit rate per user, etc. For all that, this type of solution requires the deployment of equipment at both ends of the network, which would prove to be difficult or even impossible.

### 4. SUMMARY OF THE INVENTION

The invention does not have these drawbacks of the prior art. More specifically, the invention relates to a gateway providing access to an interconnection network (ICB) of a data transmission system comprising a first local area network, called a client network, a second local area network, called a cloud network and an interconnection network connecting said client network and said cloud network, characterized in that said gateway comprises means for identifying and routing data elements from said client network to said cloud network.

According to one particular characteristic, said gateway furthermore comprises means for creating at least two tunnels for transmitting data through said interconnection network and means of selecting, from among said at least two tunnels, at least one tunnel for transmitting packets as a function of at least one predetermined parameter.

According to one particular characteristic, said types of tunnels are based on the UDP (user datagram protocol).

According to one particular characteristic, said at least one predetermined parameter belongs to the group comprising:
a state of availability of a link between said local area network and said interconnection network;
a state of availability of a link between said local area network and a mesh wide area network;
a class of traffic associated with at least one packet of data to be transmitted.

According to one particular characteristic, said gateway furthermore comprises means for identifying a destination of a packet as a function of at least one destination address of said packet.

According to one particular characteristic, said gateway further comprises:
means for detecting a break in access from said client network towards an mesh wide area network, to which said client network is connected by means of an access gateway (BFAI);
means for assigning an IP address preliminarily assigned to said BFAI gateway to a communications interface of said gateway;
means for filtering packets so that only packets intended for said cloud network are transmitted on said interconnection network.

According to another aspect, the invention also relates to a system of data transmission comprising a first local area network, called a client network, a second local area network called a cloud network and an interconnection network connecting said client network and said cloud network, said client network furthermore comprising a gateway (BFAI) for access to a mesh wide area network. According to one particular characteristic, said system further comprises, at the client network level, an access gateway to said interconnection network (ICB) comprising means for identifying and routing data from said client network to said cloud network.

### 5. BRIEF DESCRIPTION OF THE DRAWINGS

FIG. 1 is a diagram illustrating a system according to an exemplary embodiment of the present application.

### 6. DETAILED DESCRIPTION OF THE INVENTION

6.1 Reminder of the Principle of the Invention

The technique presently described proposes to resolve the problems and issues posed by “public” access to “Cloud Computing” type applications and/or services by deploying a private infrastructure, from end to end (going from the client's network to the network of the supplier of the application and/or service, i.e. cloud network) without ever passing through a third-party network, in particular the Internet.

By controlling the entire path between the client network and the “destination” cloud network, the technique of the invention addresses the issues of security, quality of service and compliance posed by Cloud Computing. The described solution targets especially firms that are multi-users of Cloud Computing because single access to a dedicated gateway secures the totality of the destinations connected to the private network provided to the user firm. This solution is deployed in parallel to the firm's main Internet access solution without in any way disturbing its working habits. It is thus, so to speak, “transparent” to non-critical flows and drastically improves critical flows and professional flows in terms of both security and quality of service.

The general principle of the invention is that of having a smart interconnection gateway available within the network of the user (i.e. the client entity wishing to access Cloud Computing services). The object of this gateway is to differentiate between the incoming (and outgoing) flows so that they are routed appropriately. The object of this gateway is also to ensure a predefined level of quality of service while at the same time ensuring failure tolerance.

This gateway is also called ICB here below.

The ICB gateway comprises means for connecting the client's network with an interconnection network. This interconnection network so to speak makes it possible to set up an interconnection between a client and a Cloud Computing service provider (CSP). This interconnection network certifies dedicated links. A dedicated link is a physical link that is “drawn” between the client and the interconnection network. It can for example be an optic fiber. A physical link can also be drawn between the interconnection network and the Cloud Computing service provider (CSP). The interconnection network manages both the transmission/reception of data coming from the clients and the routing of this data to the CSPs. To be able to ensure high quality of service, the smart interconnection gateway is capable of transmitting and receiving data on the interconnection network. The interconnection gateway also has a capacity to transmit data directly by means of a mesh network, such as the Internet, when the dedicated link is not operational or no longer operational. It is in this sense that the gateway can be called a smart gateway.

To ensure this failure tolerance of the main link, the gateway comprises mechanisms for setting up tunnels on the one hand and, on the other hand, uses a protocol that permits great liberty in the transportation of data.

6.2 Description of one Embodiment

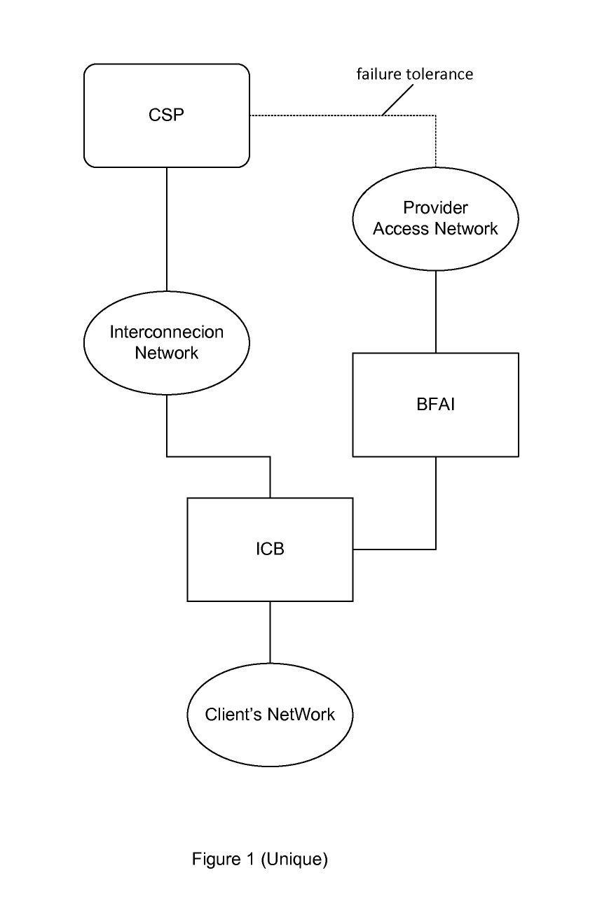

In this embodiment, as shown in FIG. 1, we present a smart interconnection gateway called ICB which, according to the invention, makes it possible (in one multihoming architecture) to set up a separation between the data transmitted to the cloud service providers (CSP) and the general data travelling through an operator network.

This gateway has two modes of functioning.
In interposition relative to an access gateway of an access provider such as an operator (this access gateway is called BFAI);
In this mode, the ICB is in interposition relative to the BFAI gateway. Its role is to intercept and divert data addressed to the CSPs towards the network dedicated to the transmission of data towards the cloud service providers;
DNS (domain name server) in a DMZ (demilitarized zone).

In this configuration, the DNS server of the client machines of the LAN will be the DNS server of the interconnection infrastructure provider. The ICB placed in a DMZ will be the “next-hop” (a mechanism which consists in knowing only the address of the next link leading to the destination, known as routing by successive hops) of the route towards the interconnection infrastructure provider at the level of the BFAI gateway.

The gateway has numerous characteristics that enable it to work transparently for the client with whom it is implemented. This gateway, as explained in general, enables the transportation of flows coming from and addressed to cloud service providers by means of an interconnection network.

6.2.1 Starting Up

The ICB starts on the network (via the PXE or “Pre-boot eXecution Environment”) and loads its kernel, its environment and its configuration through a server situated at the core of the interconnection network.

The system loaded from the network is placed in the random-access memory of the ICB. This ensures that the configuration of the gateway can be modified remotely to respond to changing needs related to the infrastructure of the networks for example.

The IP address provided by the server is assigned as a function of the MAC address (machine address) of the ICB. The server is capable of knowing the link from which the ICB makes its request and can then provide it with the appropriate link.

6.2.2 Constraints of the Dedicated Link of the Interconnection Infrastructure Provider

There are three types of streams intended for the ICB; direct access, indirect access and the administration link. The inventors have noted that it is preferable to separate these three streams.

It is possible quite simply to use VLANs (Virtual Local Area Networks or Virtual LANs) to carry out this operation. Each stream would then be isolated in a VLAN on the dedicated link. However, the dedicated link (from the ICB up to the interconnection network) is provided by a third-party operator. No guarantee whatsoever is provided as regards the carrier of a transportation of data through a VLAN.

To overcome this problem, the inventors propose to make each stream travel through a different tunnel to ensure isolation. This tunnel is for example an open VPN tunnel.

6.2.3 Security of Bridges and Routing

To avoid letting everything and anything pass through on the networks connected to the ICB, a policy of filtering is applied at the interface connected to the interconnection infrastructure provider. No filtering is applied to any item addressed to the Internet access provider.

6.2.4 Secured Tunnels

The ICB sets up tunnels (with OpenVPN) up to a tunnel concentrator at the edge of the interconnection network.

Although each of the tunnels mounted gives Ethernet connectivity (tap), two different types of tunnels can be distinguished:
Indirect (tun0): this tunnel provides direct access towards the CSPs. It offers connectivity at the IP level. This tunnel is common to all indirect accesses.
Directs (tap*): this type of tunnel provides Ethernet connectivity for any element that appears in the client's network when the link towards the interconnection network is available. The data that flows on this type of tunnel is private and encrypted before being transmitted on the Internet. One tunnel per CSP per client is used.

The advantage of using tunnels is that it leads to a situation where only one routing configuration must be set up, in giving preference to routes via the dedicated link. When the dedicated link becomes unavailable, the tunnel passes through the Internet automatically in order to ensure continuity of service.

For the tunnels, there is a choice between the protocols on which the data of the tunnel flows: TCP (transmission control protocol) or UDP (user datagram protocol).
TCP: the advantage of TCP is that it provides a sequence of mechanisms for congestion management, error control etc.. The problem is that the ICB gives Ethernet connectivity through these tunnels and that the streams traveling through the tunnel already have an error-control mechanism (at the network protocol level or at the applications level): the fact of making it pass through again on TCP constitutes a duplication.
In addition, when the dedicated link becomes unavailable, the TCP session of the tunnel is broken and the tunnel is set up again on the interface on the BFAI side. However, when the dedicated link becomes again available, the ICB will continue to use the interface on the BFAI side since the TCP session is still active. It is necessary then to cut the tunnel manually and set it up again so that it passes again through the dedicated link.
At the tunnel concentrator level, the value of using TCP sessions is that it is possible to detect situations when the TCP sessions are broken and to transmit this information to the supervisory level.
UDP: the advantage of UDP is its simplicity. It is not necessary, as in TCP, to maintain sessions. UDP does not manage congestion and error control: the stream that travels through the tunnel manages these aspects of congestion and error control on its own.
When the dedicated link becomes unavailable, the tunnel is routed on the Internet and when the dedicated link again becomes available, the tunnel passes back to this link by means of the static route towards the interconnection network.
At the tunnel concentrator level, since there is no session maintained, it is possible only to detect the fact the ICB has not succeeded in setting up the tunnels. The information then has to be transmitted to the supervisory level from the ICB.

In this particular embodiment, the use of the UDP protocol for tunnels is preferred. Indeed, the UDP protocol enables the passage from one link to another instantaneously as a function of the routing table rather than having to manually dismantle the tunnels and set them up. In addition, UDP is lighter than TCP and it is not necessary to have advanced error-control mechanisms at the tunnel since the streams that flow therein have their own mechanisms.

6.2.5 Direct Access

Certain CSPs accept the management of an IP address of the client's LAN or DMZ as a point of access to their service. Depending on the mode of operation of the ICB, the IP address managed by the CSP is either an IP address of the client's LAN or an IP address of the client's DMZ. The ICB transmits data by one of the tunnels. At the end of the tunnel, apparatuses at the core of the interconnection network are capable of extending the LAN from the client to the CSP. The security of these data elements travelling on this extended LAN is the responsibility of the client since he is part of his network.

There is a choice between two technologies for setting up the Ethernet junction between the apparatus at the core of the interconnection network and the CSPs:
VLL (Virtual Leased Line) is a completely transparent point-to-point link that lets the totality of the traffic pass through. A VLL costs very little in terms of resources.
VPLS (Virtual Private LAN Service) makes it possible to ensure one-to-many Ethernet connectivity but is more resource intensive than VLL because VPLS acts as a switch and stores an ARP table in memory (an ARP table is a table of IPv4 address/MAC address pairs contained in the memory of a computer that uses the ARP or “Address Resolution Protocol”).

Now, for each new CSP to which the client wishes to get connected, a VLL must be set up. This can make the configuration complex. It has therefore been decided to choose VPLS which enables a simpler configuration. When the client wishes to access a new CSP, it is enough to add this new destination in the VPLS.

The number of clients and CSPs planned does not result in a scarcity of resources at the apparatuses that the VPLS must manage.

The term used in this part is “IP address” because this is the protocol most frequently used. However, since the ICB acts as an Ethernet bridge, it is possible to use any protocol whatsoever above Ethernet.

6.2.6 Indirect Access

For indirect access, there are several choices pertaining to the IP address that can be used:
either directly the public IP address of the CSP;
or a private address of the interconnection network associated with the CSP;
or a public address of the interconnection network associated with the CSP;
or a private address in a range of reserved addresses provided by the client.

For data intended for CSPs that travel on the interconnection network, the public IP address of the CSP is used. If a loss of link is observed between the interconnection network and a CSP, the routing mechanisms that have been set up switch the traffic over towards the transit network (Internet) and convey the traffic towards the CSPs via the Internet network.

When the ICB is in an interposed position, it is possible to use the public IP addresses without any problem. By contrast, when the ICB is installed in a DMZ, the direct use of the public IP addresses requires a configuration of a static route for each CSP at the BFAI gateway. It is then preferred to group all the CSPs together on a range of IP addresses.

If the IP addresses of the interconnection network are used, there is a mechanism of fast saturation of the initial class of addresses. In addition, these IP addresses of the interconnection network will have to be converted into public IP addresses of the CSPs. Public IP addresses cannot be used to carry out only the translation of addresses. The entities responsible for the registers that assign ranges of public IP addresses are against this practice and can prohibit access to another IP or even withdraw access to a range of addresses.

In addition, if it is chosen to use private IP addresses of the interconnection network, it cannot be guaranteed that the range of addresses chosen in the interconnection network is not already being used by the client.

For this case, the client provides a range of private IP addresses, this range being reserved for the CSPs. This ensures that the range is not already used in the client's network and that it is not necessary to use any public IP address.

Each client therefore has a specific DNS configuration with one-to-one correspondence between the IP addresses provided (by itself) and the IP addresses of the CSPs that it wishes to access: for each IP address of the CSP, there is an associated private IP address available. This also makes it possible to take advantage of load distribution mechanisms if any (for example the round-robin mechanism) that the CSPs could have set up at their DNS.

Thus, to settle these problems, the ICBs have a table of correspondence between these IP addresses so as to be able to carry out a NAT (network address translation) on the destination of the packets.

One of the other advantages of using a range of private IP addresses for CSPs is the class of traffic perceived by the client's “VPN” operator through VPNs between the client's sites. If public IP addresses are used, the traffic through the VPN will be classified as “best effort” traffic. If private IP addresses are used, the operators will classify the traffic as “business” traffic with a better quality of service through the VPN. Thus, the use of private IP addresses makes it possible, in a way, to deceive the client's operator.

When the client accesses the CSPs, the source IP address contained in the packets is addressed to the client machine in the LAN (in the client's LAN). Since this IP address is private, it will not be routed on the Internet (or in the interconnection network) and the CSP would not know where to send its response.

A NAT (<<Network Address Translation>>) therefore needs to be made on the source address of the packets. There are two possibilities for the location of the NAT:
Just before the CSP in the interconnection network.
At the ICB in the client's network.

Since NAT is limited in terms of simultaneous connections, the solution to this problem is not to carry out the NAT at the CSP because there could be a shortage of substitution ports or because the server could even be made to collapse before reaching this stage.

By contrast, at the PCB, it is highly improbable that more than 60,000 simultaneous connections will be attained. It is therefore necessary to carry out an address translation at the ICB.

6.2.7 Security

It is not desirable for (possibly compromised) machines in the networks of the CSPs to be capable of attacking clients by means of the interconnection network. Thus, security filtering rules need to be set up to filter the traffic addressed to the clients.

These rules can be applied in the filtering tables of each ICB. A filtering common to all the clients can also be done at the core of the interconnection network. The latter solution has the advantage of centralizing the decision-making process and blocking “illegal” streams upstream before they are propagated towards the clients.

6.2.8 Downgraded Service

When the link between the ICB and the interconnection network becomes unavailable, the ICB is capable of switching over the transmission and the reception of streams to the Internet. The unavailability of the link invalidates the static routes towards the interconnection network and the ICB automatically switches the tunnels towards an access to the interconnection network through the Internet.

When it is the ICB that is unavailable (because of a hardware or software problem), the client is capable of withdrawing the ICB from his network (by connecting two network cables with a coupler for example) and can continue to use its services and all or part of the proposed services without having to reconfigure its apparatuses.

According to one specific embodiment of the invention, the ICB has a short-circuit function: the user does not have to withdraw the ICB from its network. The ICB behaves like a simple interconnection cable. This function can be implemented in two different ways: the first is to let the ICB detect by itself that the interconnection link is unavailable. In this case, the short-circuit function is implemented by the ICB. The second way is a hardware approach: when the ICB is no longer powered (for example the ICB is disconnected), the short-circuit is done automatically because of the absence of power

6.2.9 SNMP Trap

When there is a downgrading of service, an SNMP (<<Simple Network Management Protocol>>) trap must be sent to the supervision server to be processed and to immediately alert the administrators to a failure. The ICB transmits an SNMP trap when it detects an anomaly on a link or if a critical service is unavailable.

The tunnel concentrator is capable of detecting the fact that an ICB has not succeeded in resetting up its tunnels.

The SNMP traps are transmitted via the administration tunnel.

6.2.10 Resumption of Service

Depending on the mode of operation, when the dedicated link is again available , the ICB automatically goes back into its initial configuration. The ICP also transmits an SNMP trap to give an alert on resumption of the service.

6.2.11 IP Addresses

The efficient operation of the ICB requires several different IP addresses:
An IP address on the interface on the interconnection infrastructure provider side to set up the tunnels when the link is available. This IP address is distributed by a DHCP server at the core of the interconnection network, on a range of private IP addresses.
An IP address on the interface on the BFAI side to set up the tunnels when the dedicated link is unavailable. The IP address on this interface is not controlled and it is not possible to arbitrarily choose an IP address in the client's local area network. An unused IP address must be provided to prevent an addressing conflict.
A public IP address of the interconnection infrastructure provider in the tunnel for the indirect traffic, necessary to carry out the NAT and for the responses of the CSPs.
A private IP address of an interconnection infrastructure provider in the tunnel for the administration link;
In the DMZ:
   the next-hop IP address in the client's DMZ.
   IP address of the DNS server in the interconnection network.
   IP address of the CSP, in the range of addresses provided by the client.

6.2.12 QoS

Among the objects of the invention, quality-of-service management has a preponderant place. The fact of having ICBs among clients enables end-to-end control over the apparatuses of the network up to the CSP (or at least on a very large part of the path). The ICBs can then be used to carry out tests on the end-to-end quality of the network. It is also possible to identify peak and off-peak hours of use of the service by the client.

According to the invention, the ICB also has means available to set up a tunnel on the Internet in addition to the tunnels on the dedicated link. This means that it is possible to launch scenarios in parallel on both links to compare them. Thus it is possible, dynamically, to adjust the data transmission parameters, even to decide to use an additional tunnel to carry out a transmission of data in a given context.

6.3 Case of Use: Single Site

6.3.1 Interposition

6.3.1.1 Description

In this mode, the ICB is in an interposed position relative to the BFAI. Its role is to intercept and divert data intended for the CSP towards the interconnection network. The following elements are used to describe the working of the gateway and more generally of the system in this configuration. It is important to note that the gateway comprises means for implementing methods that are described here below and especially means for implementing methods for routing and differentiating the processing of the data coming from and addressed to the interconnection network and the “public” network which provides access to the Internet. These means are constituted by a processor (which is capable of applying distinct processing operations to the packets according to the situation of the network and the configuration), at least one memory (which comprises the configuration files needed for the processing of the packets) and at least three network interfaces. These interfaces can be physical modules for access to the network which can have identical or different technologies as the case may be. The object of the invention is to make the routing of the data between the networks as transparent as possible and ensure continuity of service in the case of failure of either one of the networks. Naturally, the invention ensures continuity of service towards the interconnection network: what has to be done is to ensure a continuity of service during a failure of the BFAI and during a failure of the ICB. To this end, specific means are developed by the inventors.

6.3.1.2 Interfaces and Bridge

For the three interfaces of the ICB, we have:
eth0: connects the client's LAN to the ICB.
eth1: connects the client's BFAI to the ICB. This interface has an IP address in the client's LAN.
eth2:: connects the interconnection network to the ICB. This interface has an IP address that is not controlled.

The bridge between the interfaces is known as br0.

If the client makes data travel in transit in VLANs, there are also interfaces sensitive to the VLANs (eth0.x for example), as well as a second bridge br1.

6.3.1.3 Integration into the Firm's Network

It is preferable for the ICB to be as transparent as possible in the client's network. An Ethernet bridge is set up at the ICB to continue to ensure Ethernet connectivity between the LAN and the BFAI. The client's LAN will continue to work as before (ARP, BOOTP, etc), and the BFAI will always be the default gateway of the client machines.

The inventors have had the idea of giving preference to the Ethernet bridge which enables a simpler configuration at the ICB and avoids the need for having the same IP address twice in the client's LAN. It also makes it possible to easily extend the client's LAN up to the CSPs.

6.3.1.4 DNS Server

The invention partly rests on the postulate according to which the Internet access provider (IAP) is not reliable. The inventors have had the idea of replacing the secondary DNS server provided by the DHCP server by a DNS server of the interconnection infrastructure provider (in private IP). This is useful when the link between the operator and the BFAI becomes unavailable.

There are two cases:
The client can modify the DHCP configuration provided either by the BFAI or by a DNS server in its LAN, and the secondary DNS server is directly modified.
The ICB is interposed relative to the DHCP service and the inventors have had the idea of rewriting the DHCP responses which pass through the ICB in changing the secondary DNS server.

6.3.1.5 Loading of Configurations

The interposed ICB needs to know the ranges of IP addresses that it must divert towards the interconnection network. It must therefore be capable of retrieving these pieces of information from the interconnection network.

The ICB must also be capable of periodically refreshing these ranges of addresses. 6.3.1.6 802.1Q

The data intended for the BFAI can potentially be encapsulated in VLANs.

The interposed ICB must be capable of understanding the tagged frames. For the simplicity of the configuration and the mechanisms implemented in the ICB, the Internet traffic is considered to be not separated into several VLANs. It is possible to have several LANs that pass through the ICB but only one will contain the Internet traffic that must be analyzed and, if necessary, diverted towards the interconnection infrastructure provider.

6.3.1.7 Filtering

Specific rules are integrated in order to carry out a filtering compliant with the goal of the invention.

6.3.1.8 Filtering with VLAN

If the Internet traffic is isolated in a VLAN, the inventors have had the idea of making an Ethernet bridge br1 between the eth0 and eth1 interfaces. On this bridge, all the tagged or untagged frames will circulate. The inventors have had the idea of extracting all the interesting frames from the VLAN in decapsulating them.

Once decapsulated, these packets will reach the eth0.vlan interface (with VLAN being the VLAN ID) in a non-tagged state. The direct traffic will be diverted towards the tap* interface up to CSP. The indirect traffic for its part will be routed by the ICB. The traffic on this VLAN which is not addressed to the CSPs will be reinjected in a tagged state into the local area network LAN via the eth1.vlan interface. The inventors have had the idea therefore of making the Ethernet bridge br0 between the eth1.vlan, eth1.vlan and tap* interfaces. This bridge has the same filtering rules as the bridge without VLANs.

6.3.1.9 WiFi

If client's machines of the client are directly connected by WiFi on the BFAI, there is no way to intercept the traffic towards the CSPs.

For these users:
either they will access the CSPs classically by Internet;
or the client will have to install a WiFi access point in his network so that the traffic can be intercepted.

6.3.1.10 Normal Operation

An Ethernet bridge (br0) is mounted between the three interfaces eth0, eth1, tap*.

The DNS requests pass through the Ethernet bridge without being altered. A DNS server of the operator will return the public IP address of the CSPs.

Indirect accesses to the CSPs are intercepted by the ICB which considers them to be for itself and routes them towards the interconnection network. If the packets are situated in a VLAN, they are decapsulated before being routed. A masquerading is done by the packets going out by the interface tuna

The direct accesses pass through the Ethernet bridge up to the CSPs via the interconnection network. If the packets are situated in a VLAN, they are decapsulated before being transmitted to the output interface.

6.3.1.11 Link to the Interconnection Infrastructure Provider Unavailable

When the link with the interconnection infrastructure provider becomes unavailable, the static route towards the interconnection network is made obsolete. The tunnels will pass through the default route and through the Internet.

The working of the ICB and the configuration of the clients remains unchanged.

6.3.1.12 ICB Unavailable

When the ICB becomes unavailable, the service given to the client is interrupted and his LAN is impacted. The client must withdraw the ICB from his network to set up connectivity with the BFAI.

If the ICB has a short-circuit mode, the client will have nothing to do unless the failure is at the software level.

6.3.1.13 BFAI Unavailable

1. A Word on ARP

When a machine tries to send a packet to an IP address on its local area network, it must first of all know its MAC address. The known addresses are stored in a table (which sets up the IP <-> MAC correspondence) at the operating system called the ARP cache. There are two cases:
either the IP address is present in the ARP cache and the MAC address is directly retrieved,
or the address is not present in the ARP cache and a request must be made on the network to ask for the MAC address. To this end, the machine broadcasts a who-has ARP message on the network indicating the IP address concerned. The machine possessing this IP address will respond with an is-at message containing its MAC address.

The ARP cache is regularly cleaned. All the MAC addresses that have not been recently used are eliminated.

2. Differentiation of the Streams

Three streams that can come from the client are distinguished:
Internet traffic (Facebook, Yahoo! News, YouTube, etc);
Indirect CSP traffic where the Cloud services are accessed through the public names of the service providers (Google Apps, Salesforce, etc);
Direct CSP traffic where the Cloud services are visible to the client as if they were directly integrated into his local area network (Amazon EC2 instances).

3. Mechanisms Used Up to the Exit from the Network

It is assumed that all the caches (ARP, DNS) are empty.
a. Internet traffic
   1. The browser analyses the user's entry in the address bar to extract the DNS name (or IP address) of the target from it.
   2. The browser asks the operating system to carry out a name resolution to obtain the IP address of the target.
   3. The operating system looks for information on all the means at its disposal (host file, DNS cache, DNS server).
   4. The operating system must contact the DNS server of IAP; it cannot be found on the local area network.
   5. The operating system must transmit the request to its default gateway because it is not a local IP address (determined by the routing table).
   6. The operating system searches to find out if the MAC address of the gateway is available in the ARP cache.
   7. The operating system carries out an ARP resolution to obtain the MAC of the gateway.
   8. The ICB (which acts as an Ethernet switch) lets through the request up to the BFAI which responds to the client.
   9. The operating system transmits the DNS request to the default gateway.
   10. The ICB lets through the request.
   11. Once the IP address of the target has been retrieved, the browser makes a connection with the target site by transmitting the data to its gateway (because once again there is a non-local IP address) which takes charge of routing them.
   12. The ICB lets through the connection since it does not concern a CSP.
b. Indirect CSP traffic

From steps 1 to 11, the working of the method is identical. The step 12 is modified as follows:
12. The ICB has detected the fact that the connection pertains to a CSP and diverts the data towards the interconnection network.
c. Direct CSP Traffic
   1. The application attempts a connection to the target IP address.
   2. The operating system detects that it is a directly accessible local IP address.
   3. The operating system searches to see if the MAC address of the gateway is available in the ARP cache.
   4. The operating system carries out an ARP resolution to obtain the MAC of the gateway.
   5. The ICB, which acts as an Ethernet switch between the LAN, the BFAI and the interconnection infrastructure provider allows the ARP request to be broadcast through the interconnection network.
   6. The distant machine will respond to this request through the interconnection network.
   7. The application can set up this connection with the target.
   8. The ICB (which acts like an Ethernet switch) will send the data to the target through the interconnection network.

4. Detection of the Internet Access Provider's Access Box

When the BFAI becomes unavailable, the client machines can no longer access them and all the ongoing connections are broken. At the end of a certain period of time, since the IP address no longer responds to calls, the route will become invalidated in the routing table of the operating system. From this time onwards, the customer no longer has any entry in his routing table to connect up to the distant IP address. The operating system considers the route to be inaccessible and directly returns an error code to the application without transmitting any data on the network.

The direct traffic is not affected because it does not depend on the default route entry in the routing table. Indeed, it depends on another entry which indicates that it is possible to directly connect to the range of IP addresses of the local area network. Since the ICB is still operating, it continues to relay ARP requests if any towards the remote machine and it will continue to act as an Ethernet switch and will relay the data to the target machine through the interconnection network.

For the indirect traffic, although it never travels in transit through the BFAI, it depends on the default route entry in the routing table of the operating system, since the IP addresses contacted are the “normal” IP addresses of the CSPs. When the BFAI becomes unavailable, although the physical path up to the CSPs (client-ICB-IC-CSP) is always available, the machines will remain silent because they have no default route.

To overcome this problem, the inventors have had the idea of setting up a mechanism which, when it detects the fact that the link to the BFAI is unavailable, sets up the IP address of the BFAI on the LAN interface of the ICB (eth0) to re-establish the clients' default route. In IPv4, it is also possible to send a Gratuitous ARP to accelerate the process of refreshing the cache of the client machines.

For the DNS requests, the request to the main server will have a timeout. Indeed, even if the ICB always makes the DNS traffic travel through the interconnection network, the DNS server of the operator will refuse the connection because it does not come from one of its clients. The DNS request to the primary server is therefore allowed to lapse and the system then switches over to the secondary DNS server (that of the interconnection infrastructure provider). The DNS requests will then be routed towards the interconnection network by the ICB.

For the indirect traffic, the ICB has become the default gateway of the machines of the clients' LAN. The traffic is therefore addressed to the ICB (and no longer to the BFAI). The ICB will route the packets without forcing the process as before.

If the traffic is encapsulated in a VLAN, there will be no need to decapsulate it since it generally reaches the Ethernet eth0.vlan.

To avoid having to route all the traffic coming from the LAN, the inventors have had the idea of letting through only the packets towards the CSPs and the DNS server of the interconnection infrastructure provider. The traffic addressed to the Internet will not travel in transit by the interconnection network and will receive ICMP error messages.

A second problem also exists when the BFAI also acts as a DHCP server. Indeed the machines, the IP address of which has been served via DHCP, ultimately stop using these IPs if the DHCP server no longer responds (tested under Linux and Windows).

A first solution would be to deploy a DHCP server fully. This server would replace the ICB for this role. Thus, when the BFAI becomes unavailable, the DHCP server still responds and the client machines will keep their IPs and continue to communicate with the direct CSPs.

Another solution would be to have a secondary DHCP server which would communicate with that of the BFAI to keep up to date and take over in the event of a failure of the BFAI. Thus, the single point of failure would be eliminated.

However, these two solutions are not suitable because it is desired to be as unintrusive as possible in the user's network.

The solution is to simulate a DHCP server at the ICB to ensure continuity of service. No new IP addresses will be allocated in order to avoid having conflicts. However, at the ICB level, the inventors have had the idea of simulating the messages that the DHCP server would have sent in normal times so that the clients do not realize that the DHCP server of the BFAI is unavailable and continue to transmit on the network.

6.3.1.14 Operator Link Unavailable

The loss of the link with the Internet operator (but not the BFAI) will prompt the expiry of the timeout of the DNS request to the primary DNS which is then switched over to the DNS of the interconnection infrastructure provider. The ICB will route the DNS request to the server of the interconnection infrastructure provider.

The indirect access will be done as before and will be intercepted by the ICB. The content addressed to the Internet will not travel through the interconnection network and will receive ICMP error messages.

The direct accesses are thus not impacted.

6.3.1.15 Resumption

When the ICB detects the fact that the environment is again in its normal state, it resumes its original configuration. The static route to the interconnection infrastructure provider again becomes available and the tunnels can again pass through the interconnection network.

6.3.1.16 Spanning Tree

If the user's network is in a triangular configuration with the spanning tree to secure its LAN, and if the BFAI acts as one of the switches, it will not be possible to place classic ICB in an interposed position. It will be necessary to have a box with at least one additional network interface to be able to play the role that was played by the BFAI. The fact of placing this box will not change the redundancy capacity of the clients' network. If the BFAI (in the former configuration) or the ICB (in the new configuration) becomes unavailable, access to the Internet also becomes unavailable.

It is also possible, with a box comprising two pairs of cards with a short circuit, to improve the robustness of the novel network. If the ICB becomes unavailable, the two cards will go into short circuit and the access to the Internet is always possible. For reasons of feasibility of the box and cost, this approach cannot be envisaged as a normal offer but rather as an option to which the client can subscribe for an extra cost.

Another approach could be that of adding a switch before the ICB. However, this solution cannot be envisaged for several reasons:
A switch would have to be added to the clients' network. This is an apparatus for which it is not sought to have responsibility.
This change of architecture makes it possible to keep the redundancy in the LAN but the redundancy with the BFAI and Internet would be lost.

6.3.1.17 Learning and White List

The decision to divert or not divert traffic towards the interconnection network is based on the destination IP address of the packet. When the IP address is unknown, the default behavior is to let through the data to the BFAI.

However, it is possible to learn certain pieces of information from the packets that pass through the ICB.

The scenario of access to a CSP can be divided into three steps:
1. From the access address to the CSP, the client will first of all extract the domain name therefrom and carry out a DNS resolution to know the destination IP address towards which it must get connected;
2. Once the communications channel with the target server is open, the client will send out a request;
3. After analyzing the submitted request, the server will send back the appropriate content and close the communications channel.

If a client accesses the CSP in making a DNS request and if the ICB is in an interposed position relative to the DNS server, it detects the DNS request towards a CSP and listens to the response to learn the IP address.

More particularly, when the ICB is in an interposed position relative to the DNS server (for example if this service is integrated with the BFAI), the ICB can observe the DNS resolution process. Thus, the ICB detects the DNS request pertaining to a domain sent by the client. This request contains the type of information desired as well as the target of the question. However, this request does not contain information relevant to the process presently described, namely the IP address of the target server. It is therefore not necessary to carry out a particular treatment of the “question” type DNS packets. However, the “response” type DNS packets are of interest in the context of the learning process. Indeed, these packets contain both the response of the DNS server with the requested data and a copy of the initial question.

In analyzing these packets, it is possible for example to retrieve the IP addresses associated with a domain.

In this embodiment, the analysis of a DNS packet starts with a step for verifying at least a part of the state field and counting field. The goal is to verify the type of DNS packet, the response code, the number of questions and responses. This verification makes it possible not to process the packets of a wrong type or packets that do not contain responses and it prevents the process from being excessively resource-hungry.

When the state fields allow it, the question (i.e. the initial request) included in the packet is analyzed. More particularly, a question of the (Qtype fields) type is sought for. In the case of IP addresses, the question must relate to a type A DNS recording. The analysis therefore continues with a step of making, within the packet, a Qtype search, the value of which is “A”.

When an “A” type question is identified, the name of the associated domain is extracted by means of an extraction step. This domain name is compared, in a comparison step, with entries of a database. This database includes domain names that are associated with the “CSP” traffic. The structure of this database is optimized to take advantage of the tree-like structure of the DNS.

When the domain name of the DNS packet corresponds to an entry in the database, the exploration of the DNS packet is continued by analyzing each response. After making sure that the responses are of the right type, the IP address is extracted from the packet.

This address is then compared with the entries of a second database that contains the learned IP addresses, and for which the process of traffic diversion will be implemented. This second database is called the list of learned IP addresses. If the IP address has not already been learned, then it is added as an entry into this database as well as to the traffic diversion process. When the address has already been learned, the date of use of this address is updated (so that it can be tracked thereafter).

This second database is optimized to make it possible to carry out fast research. Thus, each insertion or elimination is done in such a way that the list of learned IP addresses is always ordered. This means that it is possible to make a dichotomic search when it is sought to know if the IP is learned or not.

If the ICB is not interposed relative to the DNS server, it is always possible to learn information, from the Host field of the HTTP requests for example. More particularly, it is possible to learn IP addresses by observing the exchanges made on the network. For example, an HTTP request addressed to a CSP server will contain the target IP address in the TCP headers, but also the target domain name in the host field of the HTTP headers. However, although this method is valuable as a standby method, it is sub-optimal for two reasons:
To access the Host field of an HTTP request, it is necessary to rebuild the TCP session to be able to extract effective data therefrom and then go back in the layers to access the HTTP headers. This is slow and costly in terms of resources.
Almost all the exchanges with the CSP are done in a secured way via the HTTPS protocol. It is not possible to make trivial access to the HTTP headers beneath the security layer.

Thus, when possible, preference is given to learning in observing the DNS exchanges as described here above.

To keep the traffic diversion process as efficient and as relevant as possible, it is important that the list of IP addresses learned should contain no superfluous entry and should be strictly limited to the set of target IPs used by the client.

The first mechanism consists in making an automatic cleaning of the IP addresses. This cleaning is based on their frequency of use and their date of learning. It is indeed not necessary to keep an IP address in memory if it has not been used for a long time. In this case, an automated process takes charge of detecting these obsolete IP addresses and eliminating them from the database and from the decision-making process. To this end, as explained further above, the database of the learned IP addresses furthermore includes a field used to mark the date of the last use of the IP address in question.

When an ICB learns a new IP address, it transmits an alert to a verification server in the interconnection network. The server can if necessary check to see if this new IP corresponds to a change in the DNS recordings of the CSP. Thus, the learning of a new IP address can be subjected to validation by a master server. Indeed, an IP address learned by observing the DNS request can finally be entrusted to an Internet transit entity by the interconnection network, because it is not present in the tables for specific routing towards the CSPs. If such is the case, the traffic would have been diverted to finally send it back to the Internet. To prevent this unnecessary hop by the interconnection network, the ICB can submit the learned IP address to a validation server within the Cloud network. This server takes responsibility for verifying the relevance of the IP address and informs the ICB about it. So long as the IP address is not validated by the master server, it is not added to the database and to the diversion process.

In addition, to accelerate the processing of unknown IP addresses, the ICB can use this learning mechanism to set up a white list of IP addresses that must be constantly allowed to pass towards the BFAI (typically all the IP addresses used that do not correspond to CSPs). Thus, sending back this information also makes it possible, when updating the system, to automatically launch the ICB with this static list. This has the effect of accelerating the processing of the streams addressed to the CSPs.

The presence of this list will avert the need for the ICB to go back to the applications network at each encounter with an unknown IP.

To prevent the list from being too big, a cleaning system based on frequency of use and age of the IP addresses eliminates superfluous IP addresses.

However, this solution has several technical problems, and this means that this mechanism can be replaced by another one.

For the secured streams, nothing can be learned from the applications network (HTTPS for example).

Although, for the DNS requests, the reading of the information is a fairly simple process (because of the UDP) it becomes far more complicated and resource-hungry if it is preferred to do this on all the HTTP requests for example. It is necessary to rebuild the TCP session before the applications layer and the Host field can be accessed.

If an ICB learns a new IP, it can happen that, when it travels in transit on the interconnection network, it is directly routed to the exterior because it is unknown to the routers. Resources would have been consumed to finally send the packet on the Internet.

Although the DNS servers of the interconnection infrastructure provider are supposed to be as up to date as possible, it is possible to use the mechanism for detecting unknown IP addresses via the DNS requests only (and if this is not too costly) to issue alerts and enforce an active verification of the DNS recordings at the core of the interconnection network.

The methods described here above are implemented by equivalent means which can take the form of software or hardware modules, capable of being integrated into the ICB.

Although the present disclosure has been described with reference to one or more examples, workers skilled in the art will recognize that changes may be made in form and detail without departing from the scope of the disclosure and/or the appended claims.

1. A gateway for access to an interconnection network (ICB) of a data transmission system comprising a first local area network, called a client network, a second local area network, called a cloud network, and an interconnection network connecting said client network and said cloud network, wherein said gateway comprises:
means for identifying and routing data elements from said client network to said cloud network, said means for identifying and routing comprising:
means for learning IP addresses to be routed as a function of data transmitted on said client network addressed to a third network called a BFAI network.

2. The gateway according to claim 1, further comprising means for creating at least two tunnels for transmitting data through said interconnection network and means of selecting, from among said at least two tunnels, at least one tunnel for transmitting packets as a function of at least one predetermined parameter.

3. The gateway according to claim 2, wherein said types of tunnels are based on the user datagram protocol (UDP.

4. The gateway according to claim 2, wherein said at least one predetermined parameter belongs to the group consisting of:
a state of availability of a link between said local area network and said interconnection network;
a state of availability of a link between said local area network and a mesh wide area network;
a class of traffic associated with at least one packet of data to be transmitted.

5. The gateway according to claim 1, further comprising means for identifying a destination of a packet as a function of at least one destination address of said packet.

6. The gateway according to claim 1, further comprising:
means for detecting a break in access from said client network towards an mesh wide area network, to which said client network is connected by means of an access gateway (BFAI);
means for assigning an IP address preliminarily assigned to said BFAI gateway to a communications interface of said gateway; and
means for filtering packets so that only packets intended for said cloud network are transmitted on said interconnection network.

7. A system of data transmission comprising:
a first local area network, called a client network, comprising a gateway (BFAI) configured to access to a mesh wide area network;
a second local area network called a cloud network;
an interconnection network connecting said client network and said cloud network; and
at the client network level, an access gateway to said interconnection network (ICB) comprising means for identifying and routing data from said client network to said cloud network.
